(19) United States
(12) Patent Application Publication
(10) Pub. No.: US 2022/0109718 A1
(43) Pub. Date: Apr. 7, 2022

(54) METHOD AND SYSTEM FOR ESTABLISHING A WEB-BASED VIRTUAL MODULE DESKTOP FOR SOFTWARE MODULE SELECTION AND EXECUTING THE SYSTEM

(71) Applicant: GAMERNET CORP., Atlanta, GA (US)

(72) Inventors: James Walton HENLEY, Atlanta, GA (US); Christopher Scott MCCAULLEY, Gastonia, NC (US)

(73) Assignee: GAMERNET CORP., Atlanta, GA (US)

(21) Appl. No.: 17/062,177

(22) Filed: Oct. 2, 2020

(51) Int. Cl. H04L 29/08; G06F 3/0486; G06F 3/0482

(52) U.S. Cl. CPC H04L 67/025; H04L 67/306; G06F 3/0482; G06F 3/0486

(57) ABSTRACT

A method and system for establishing a web-based virtual, module desktop on a client computer for selection and execution of software modules The method includes storing at least one or more software modules on a server memory module repository; executing within a computer processor a computer program for causing the computer processor to: access the server memory module repository; to serve software modules stored therein to a web-based client computer upon receipt of a user requested selection; and to allow a user to select software modules for execution by a drag and drop function performed at the client computer; and serving one or more modules onto the web-based client computer virtual module desktop from a module listing served to the web-based module desktop computer for display and access by a user and or group.

### FIELD

A method and system are disclosed for establishing a web-based virtual, module desktop on a client computer for selection and execution of software modules without storage of the modules on the client computer, and an associated server for hosting/serving the modules.

### BACKGROUND INFORMATION

It is known to configure server/client computer systems wherein a server is configured to store an application that can be accessed and downloaded to a client computer by the client computer. It is also known that a server can host an application for interactive access and use by one or more client computers in shared fashion.

From the client side, it is known that software can be downloaded from internet based cloud storage for storage at the client computer, where the software can be executed and used by the client computer to interface. Once downloaded, the user client computer can interact with other client computers which have also downloaded the software via a server host site in, for example, a shared internet work or gaming experience.

In known systems, a desktop graphical user interface is executed on the client computer by the client computer's operating system. To the extent software is to be executed at the client computer, the software is downloaded from a cloud storage network to the client computer for execution thereon, or is executed by interfacing with a cloud server web page that is hosted on the cloud and simply accessed by a user's client computer.

Accordingly, it would be desirable to configure a server/client based system in which the client side user experience can be better configured in a collaborative approach with a cloud based server for multi-user experiences that offer enhanced efficiency, enhanced interaction capabilities, and more robust software development and enhancement opportunities.

### SUMMARY

A system (desktop side) is disclosed for establishing a web-based virtual, module desktop on a client computer for selection and execution of software modules, the system comprising: a local memory for storing a web browser; a computer processor configured to access the memory and execute the web browser; and a general user interface configured to display a web-based module desktop that runs within the web browser; wherein the computer processor is configured to receive from an external server memory module repository at least one or more software modules, and to allow a user to drag and drop modules onto the web-based module desktop from a module listing received from the external server memory and displayed on the web-based module desktop.

A system (server side) is also disclosed for establishing a web-based virtual, module desktop on a client computer for selection and execution of software modules, the system comprising: a server memory module repository storing at least one or more software modules; a computer processor configured to: access the server memory module repository; to serve software modules stored therein to a web-based client computer upon receipt of a user requested selection; and to allow a user to select software modules for execution by a drag and drop function performed at the client computer; the computer processor also being configured to serve modules onto the web-based client computer virtual, module desktop from a module listing served to the web-based module desktop computer for display and access by a user and or group.

A method (server side) is also disclosed for establishing a web-based virtual, module desktop on a client computer for selection and execution of software modules, the method comprising: storing at least one or more software modules on a server memory module repository; executing within a server side computer processor a computer program for causing the computer processor to: access the server memory module repository; to serve software modules stored therein to a web-based client computer upon receipt of a user requested selection; and to allow a user to select software modules for execution by a drag and drop function performed at the client computer; and serving one or more modules onto the web-based client computer virtual module desktop from a module listing served to the web-based module desktop computer for display and access by a user and or group.

### BRIEF DESCRIPTION OF THE DRAWINGS

Other objects and advantages of the present disclosure will become apparent to those skilled in the art upon reading the following detailed description of exemplary embodiments, in conjunction with the accompanying drawings, in which like reference numerals have been used to designate like elements, and in which:

FIGS. 1a and 1b show an exemplary system wherein a desktop side (FIG. 1a) is provided for establishing a web-based virtual, module desktop on a client computer for selection and execution of software modules accessed via a server side computer processor (FIG. 1b);

FIG. 2 shows an exemplary system and method for user module creation and upload;

FIG. 3 shows an exemplary system and method for module listing module drag and drop to module desktop operation;

FIG. 4 shows an exemplary system and method for module desktop module arrangement;

FIG. 5 shows an exemplary system and method for module desktop module expand operation;

FIG. 6 shows an exemplary system and method for module desktop module shrink operation;

FIGS. 7a-7d depict exemplary flow charts of a method which can be implemented according to the present disclosure for a system having server side/client side interaction to establish a virtual, module desktop; and

FIGS. 8a-8f show exemplary flow charts for client-side module creation and use, including module access and display on a client computer.

### DETAILED DESCRIPTION

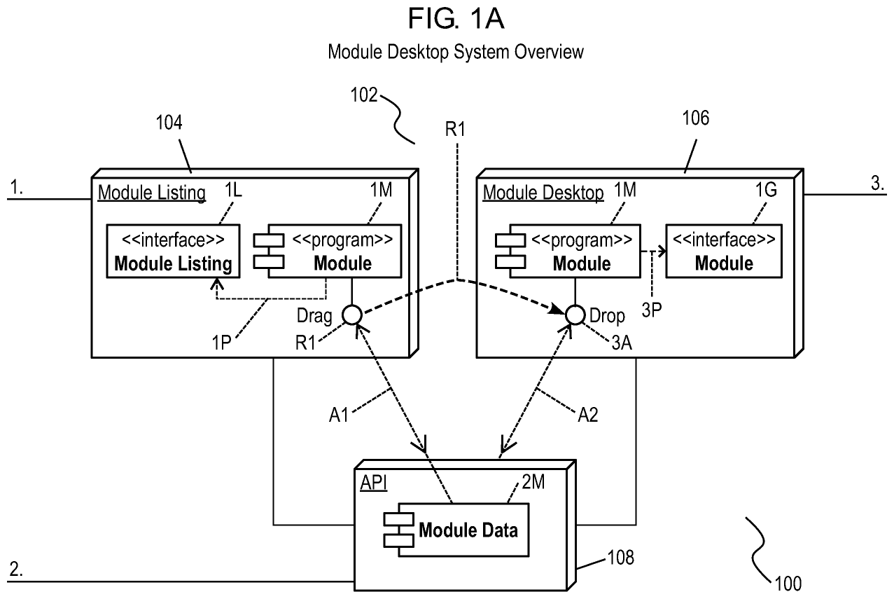

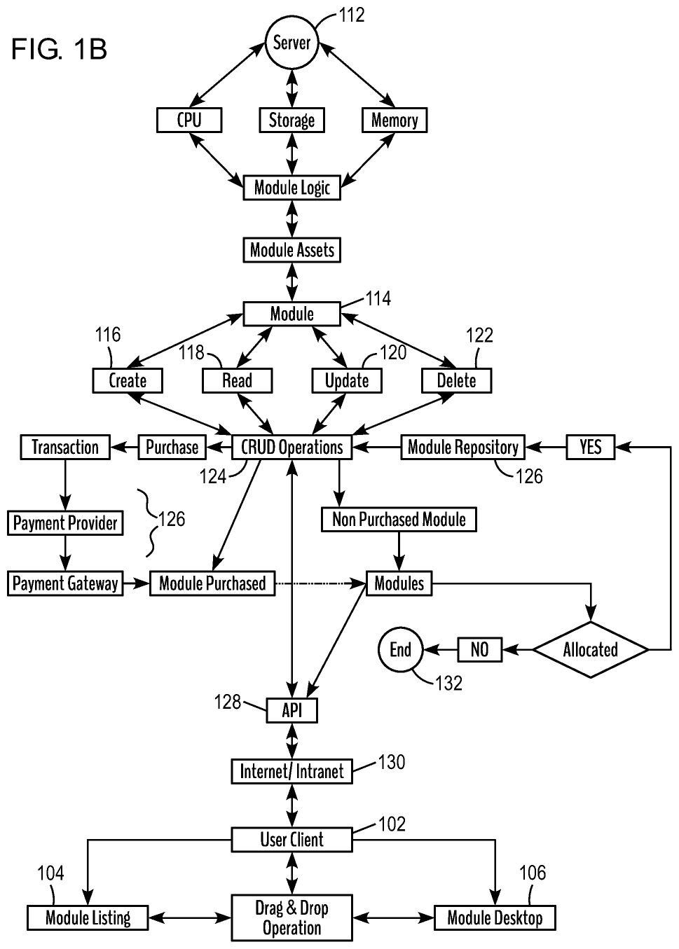

FIGS. 1a and 1b show an exemplary system wherein a desktop side (FIG. 1a) is provided for establishing a web-based virtual, module desktop on a client computer for selection and execution of software modules accessed via a server side computer processor (FIG. 1b).

### Client Side Operation

The FIG. 1a system, and an associated method, can establish a module desktop on the client computer in which modules can run-on-demand via drag-and-drop from a module listing served to and displayed on a graphical user interface (GUI) of the module desktop. Functionality can be provided by the graphical user interface and interaction with a server via an application program interface (API), with interaction occurring in an exemplary embodiment over the internet/intranet.

Modules can contain resources and logic that provide on-demand graphics, text, application logic, multimedia, and other developer built assets to provide real-time functionality with interactions from the user being handled by the module desktop GUI &/or an internet/intranet based API. Dragging and dropping modules from the module listing to the module desktop provides module based features and interactivity for the end user at the client computer.

Multiple modules may be dragged and dropped onto the module desktop and customized by the user to customize their module desktop experience. Users may create and build modules and submit those modules to the module listing to create custom methods, graphical, textual, & logical for use in the client computer system. Modules can be minimized, maximized, moved (via drag-and-drop), or removed from the module desktop to provide a unique tailored experience for the end user experience.

In accordance with exemplary embodiments, the FIG. 1a system includes a local memory for storing a web browser.

In accordance with exemplary embodiments, the FIG. 1a system includes a computer processor configured to access the memory and execute the web browser.

In accordance with exemplary embodiments, the FIG. 1a system includes general user interface configured to display a web-based module desktop that runs within the web browser;

The computer processor can be configured to receive from an external server memory module repository at least one or more software modules, and to allow a user to drag and drop modules onto the web-based module desktop from a module listing received from the external server memory and displayed on the web-based module desktop.

As referenced herein, the module desktop can be configured as a software application having a container that acts as a framework to keep track of one or more applications and utilities currently active for a user on a server side. The web based module desktop can run natively in the user's web browser to allow modules to be added to the module desktop module listing, or library, by the server computer without the need to install modules. For example, a user of the client computer can add a module to the module list for a specified user and or group and or client computer by simply dragging and dropping modules onto the module desktop from the module repository. The modules can be configured to behave much like real desktop applications and can for example have two unique view modes on the client computer GUI, such as: a compact display mode; and an expanded display mode.

The module repository retained at the server side computer can be configured as a container containing applications or utilities that are inactive to the client computer module desktop unless authorized use is afforded by either selection or purchase by the client computer user. In exemplary embodiments, this container can function as a type of marketplace to access and/or purchase new applications or utilities.

A module desktop layout can be constructed as a framework that allows the user to set up different arrangements of applications or utilities in a compact display mode to change readouts of information to their user module desktop, also referred to herein as a type of user headquarters for configuring the virtual module desktop computer. The module layout can allow a user to setup arrangements of applications and utilities in expanded display mode at the client computer module desktop to view selections of information in the module desktop. Modules can be arranged and saved onto multiple “module desktop layouts” that can be archived and restored at a later date per each user's preference, thus allowing a user at a client computer to execute functions of saving modules, module window arrangements, positions, and sizes in a cloud storage.

In accordance with exemplary embodiments, the FIG. 1a system computer processor can thus be configured to request remote execution of a software module without local storage of the software module. The software module to be executed can, for example, be at least one of an application software module or a utility software module.

In accordance with exemplary embodiments, the FIG. 1a system the computer processor can be configured to request display of a software module at the client computer in either the compact view display mode or an expanded view display mode, in response to a desired default and/or user selection.

In accordance with exemplary embodiments, the computer processor can be configured to allow the client computer to request access (e.g., purchase) of a software module for storage in the module repository, such that upon selection and/or purchase the software module will be stored with a link to the client computer or to a specific user and or group.

In accordance with exemplary embodiments, the computer processor can be configured to allow the client computer to develop a user-configured software module for remote storage in a module repository with a link to the client computer or to a specific user and or group.

In accordance with exemplary embodiments, the computer processor can be configured to establish a web-based virtual module desktop that is unique to the client computer or to a specified user account identified by a user of the client computer and or to a group.

In accordance with exemplary embodiments, the FIG. 1a system can be configured in combination with a server memory module repository resident on a cloud server for storing at least one or more software modules.

In accordance with exemplary embodiments, the FIG. 1a system can be configured in combination with a computer processor configured to access the server memory module repository; and to serve software modules stored therein to the web-based client computer upon receipt of a user requested selection by the web-based client computer.

Thus, exemplary embodiments are directed to a client side computer that can display a virtual web-based module desktop to interact with a cloud based storage whereby modules selected by a user can be viewed at the client side as an available and executable software module that the user can utilize without having to download the module to the client side module desktop computer system.

### Server Side Operation

FIG. 1b illustrates a system on a server side, such as a cloud based server, for establishing a web-based virtual, module desktop on a client computer illustrated in FIG. 1b as the “user client” for selection and execution of software modules. The server side interfaces with the user client over the internet or an intranet using an API. The server includes a CPU, storage and memory associated with the creation, reading, updating and deleting (CRUD) of modules configured using module logic and module assets.

CRUD operations are interfaced with allocated modules that can be purchased and made accessible in the module listing on the client-side module desktop.

The server side system's module repository stores at least one or more software modules.

A computer processor on the server side can be configured to access the server memory module repository; to serve software modules stored therein to a web-based client computer upon receipt of a user requested selection; and to allow a user to select software modules for execution by a drag and drop function performed at the client computer;

The server side computer processor can be configured to serve modules onto the web-based client computer virtual module desktop from a module listing served to the web-based module desktop computer for display and access by a user and or group.

The server side computer processor can be configured to execute a software module in response to user commands from a client computer without serving the software module to the client computer.

The software module to be executed can for example be at least one of an application software module or a utility software module.

The computer processor can be configured to serve a software module in, for example, either a compact view or an expanded view in response to a user selection received by the computer processor.

The computer processor can be configured to allow a client computer to request access to (e.g., purchase of) a software module for storage in the module repository with a link to the client computer or to a specific user and or group.

The computer processor can be configured to allow the client computer to develop a user-configured software module for storage in the module repository with a link to the client computer or to a specific user and or group.

The computer processor can be configured to establish a web-based virtual module desktop that is unique to a specified client computer or user account and or group.

The server side system can be configured in combination with a web-based client computer configured for accessing the server memory module repository storing at least one or more software modules.

### Method of Operation

The systems as described can implement a method (e.g., server side) for establishing a web-based virtual, module desktop on a client computer for selection and execution of software modules. The method can include storing at least one or more software modules on a server memory module repository; and executing within a server side computer processor a computer program for causing the computer processor to:

access the server memory module repository;

serve software modules stored therein to a web-based client computer upon receipt of a user requested selection; and

allow a user to select software modules for execution by a drag and drop function performed at the client computer.

The method can include serving one or more modules onto the web-based client computer virtual module desktop from a module listing served to the web-based module desktop computer for display and access by a user and or group. The server side computer processor can be configured to execute a software module in response to user commands from a client computer without serving the software module to the client computer. The computer processor can be configured to serve a software module in either a compact view or an expanded view in response to a user selection received by the computer processor.

The computer processor can be configured to allow a client computer to request access to (e.g., purchase of) a software module for storage in the module repository with a link to the client computer or to a specific user and or group. In addition or alternatively, the computer processor can be configured to allow the client computer to develop a user-configured software module for storage in the module repository with a link to the client computer or to a specific user and or group.

The server side computer processor can be configured to establish a web-based virtual module desktop that is unique to a specified client computer or user account and or group. As such multiple users and/or client commuters can access the server computer processor to maintain unique accounts associated with their user credentials and/or their client computer.

In accordance with exemplary embodiments, various possible actions that can be performed via operation of a client side computer module desktop include adding new application functionality to the client side; expanding module information as displayed in an expanded display mode at the client computer GUI from a compact display mode, or vice versa; and/or saving module configurations and/or display modes remotely from the client computer.

The adding of new application functionality regarding adding new application function accessibility to the user's virtual module desktop can be implemented by drag and drop operations. An exemplary method for adding applications to a module desktop in-real-time can be performed as described without the need to install anything on the user's local client computer by simply dragging and dropping icons or names of applications from the module repository displayed at the client computer GUI into an active list of accessible modules for that client computer or user and or group.

Regarding the expanding modules display mode, by clicking on a module in compact mode on the module desktop it will change to expanded mode providing more detailed information and settings. By clicking on a module in expanded mode on the module desktop it will change to compact mode providing basic information.

Regarding the saving of a layout, a setup of a series of modules on the module desktop can for example be in either in compact or expanded mode on a module by module basis, or on a collective basis. After establishing a desired display mode for modules associated with a given client computer or user and or group, the user can for example activate a save layout button and name the layout to be displayed in the module repository for later selection by the user, other users, and or groups.

The display of a module in a compact or expanded display mode can be performed by a module desktop utility as follows:

Compact Mode: A smaller display view of a module that can be simply an icon or a small set of data that can update in real-time or contain static data.

Expanded Mode: A larger and adjustable view of a module that contains the full module data and acts much like an application.

With reference to FIG. 1a, an overview description of the system and functionality will follow a brief discussion of an exemplary Table of the References and exemplary Labels included therein:

### Table of References in Exemplary Embodiment

Below is an exemplary general listing of descriptions for different letters/numbers in labeling of the FIG. 1a to FIG. 6 diagrams.

1—Module Listing

2—API/Module Data

3—Module Desktop

A—API Module Interaction

C—Interaction and transfer between the user, module listing, api, & module interface

G—Interface Module

L—Interface Module Listing

M—Program Module

P—Module Program & Module Interface Interaction

R—Drag, Drop, &/or Resize Operations

U—User

T—Time

### Exemplary Labels

1. Module Listing

A Repository that contains modules available to an end user for use on a client computer Module Desktop.
1L. <<interface>> Module Listing

The interface to display/show a <<program>> Module (1M) on the Module Listing (1)
1M. <<program>> Module

The programmatic logic that executes and runs code & assets within the Module Desktop System.
1P. <<program>> Module to <<interface>> Module Listing

The programmatic and data interaction between the <<program>> Module (1M) & the <<interface>> Module Listing (1M) to provide a listing of the Module within the Module Listing (1)
R1. <<program>> Module drag and drop operation

The interaction from the Module Listing (1) to the Module Desktop (2) in which a Module is added to the Module Desktop (2) via a drop operation (3A).

1. API

The backend application program interface.
A1. <<program>> Module & API (2) Interaction

The interaction with the API (2) & the <<program>> Module (1M) during the Drag operation (R1) and/or the Module Listing (1) Interaction.
A2. API (2) interaction with the Module Desktop (3).

The interaction with the API (2) & the Module Desktop (3) in which data from the API (2) is loaded onto the Module Desktop (3)
2M. Module Data

The data for/from the <<program>> Module (1M) that is loaded from the API (2)
3A. Drop Operations

The process of loading a <<program>> Module onto the Module Desktop (2)
1G. <<interface>> Module

The graphical and/or textual interface in which a <<program>> Module (1M) is displayed on the Module Desktop (3)
3P. <<program>> Module to/from <<interface>> Module interaction

The programmatic interaction between the <<program>> Module (1M) & the <<interface>> Module (1G) in which graphics, text, or other assets can be displayed on the Module Desktop (3).
U. User Input

Exemplary inputs from a User
1U. User

The person/user interacting with the system
C1. User Program Module Creation

The action of a user creating a <<program>> Module (1M)
C3. <<program>> Module interaction

The User's interaction to transport, load, or upload a <<program>> Module to the API (2)
C4. <<program>> Module listing interaction

The User's (1U) interaction with the <<interface>> Module Listing (1L) in which a module is loaded/installed to the <<interface>> Module Desktop (3).
2U. <<api>> Upload

The action of uploading a <<program>> Module to the API (2) to add the User's creation to the <<interface>> Module Listing (1L)
C5. <<api>> Upload to the <<interface>> Module Listing

The action in which a <<program>> Module is approved to be listed on the <<interface>> Module Listing (1L)
1L. <<interface>> Module Listing

The graphical interface in which modules are listed
3A. Drop Operation

The drop operation in which a Module is loaded onto the <<interface>> Module Desktop (3)
1M. <<program>> Module

The <<program>> Module loaded onto the <<interface>> Module Desktop
R2. Drag & Drop operation within the Module Desktop

The action in which a module is dragged and dropped onto a new location on the Module Desktop (3) from within the Module Desktop (3).
R3. Expand operation within the Module Desktop

The action in which a module is expanded from a non-expanded state on the Module Desktop (3) from within the Module Desktop (3).
R4. Shrink operation within the Module Desktop

The action in which a module is shrunk from an expanded state on the Module Desktop (3) from within the Module Desktop (3).
T1. Time duration

The time that has passed from an action.

### FIG. 1a, 1b System Overview

Turning now to the FIG. 1a, 1b overview, a discussion of the exemplary system 100 and associated method will now be provided. The exemplary client computer in an exemplary embodiment includes a GUI (e.g., display, keyboard, and/or other elements), and is configured to include three components: a module listing 104, a module desktop 106, and an access to a server API 108. As already discussed, the client computer interfaces to a server via the API connection that can for example, manage access to server side module data, and allow the client side to use drag and drop operations for transferring authorized modules from a module listing to the module desktop for client side use.

The Module Listing (104) provides, via a graphical user interface (1L) of a client side computer 102, a user with a list of modules available to be dragged and dropped (R1) onto the user's Module Desktop system from a server that can interface to the client computer via, for example, an API direct connection or via the cloud and an associated internet or intranet connection. Interactions between the Module Listing (1) and the Module Desktop (3) can utilize an on board API (2) which provides module data to be used (A1 & A2).

Exemplary components/component functionality associated with the FIG. 1a client computer for selecting among modules in the module listing and adding them to the module desktop of a given user is as follows:

1. Module Listing
1L. <<interface>> Module Listing
1P. Module to Module Listing Interface
1M. <<program>> Module
R1 Drag Operation.

2. API
2M. Module Data Acquired Via A Server-Side API

3. Module Desktop
1M. <<program>> Module
3P. Module to/from Module Interface Interaction
3A. Drop Operation.
1G. <<interface>> Module
R1. Module Listing Module Drag & Drop to Module Desktop Operation
A1. API to Module Listing Connection Transport
A2. API to Module Desktop Connection Transport

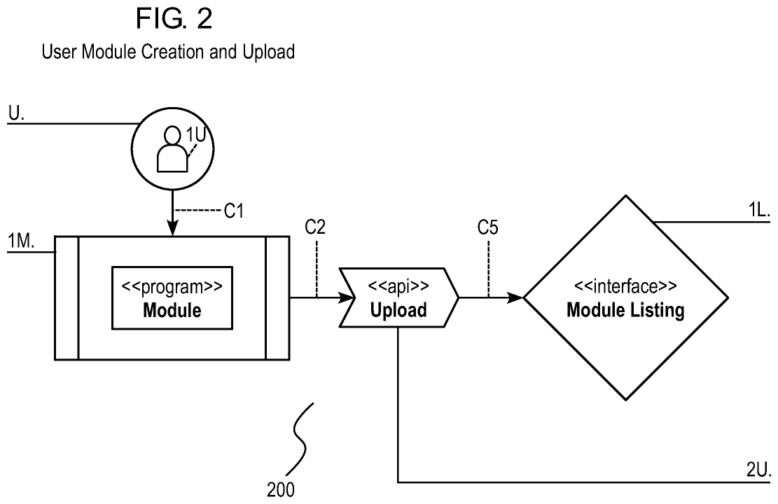

### FIG. 2 User Module Creation and Upload

FIG. 1b illustrates an Exemplary functionality overview of the system server 110 with the client side 102. A server side includes server 112 having, for example, a CPU, storage and memory with module logic and module asset, to establish and provide access to ach given module 114 via create 116, read 118, update 120 and delete 122 (CRUD) operations. Modules can for example, be accessed at the client side via CRUD operations 124 and payment transactions 126 to have desired modules allocated via a module repository 126 and server side API 128 to the client side over, for example, an internet, intranet, or direct connection 130. Only modules created and allocated are accessible; if not such modules are allocated the FIG. 1b process ends with the client access configured accordingly. (block 132). Note that modules which are not accessible by a given client can remain on the server side as for example, non-purchased modules.

FIG. 2 illustrates functionality 200 associated with the client side computer for creating and uploading a user created and/or user modified module, wherein labels “U” designate user operations, “M” designate module operations “L” designate listing operations and “C” designate client operations.

Description: A User (1U) creates (C1) a program module (1M) that is uploaded (C1) via an API (2U) to (C5) the Module Listing Interface (1L).
U. User Input
   1U. User
1M. <<program>> Module
2U. <<api>> Upload
1L. <<Interface>> Module Listing
C1. User program module creation
C2. Process to upload a module to the API
C5. Module listing approval process

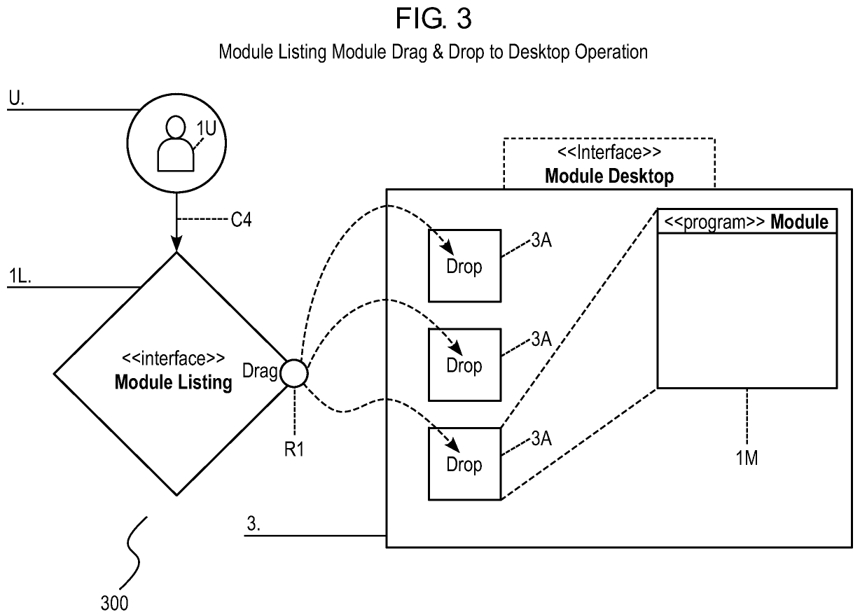

### FIG. 3 Module Listing, Module Drag and Drop to Module Desktop Operation

FIG. 3 illustrates functionality 300 associated with the client side computer for module drag and drop between the module listing and the module desktop.

Description: A User (1U) views (C4) the Module Listing Interface (1L) and selects a module (1M) using a drag (R1) & Drop (3A) onto the Module Desktop Interface (3) at any position on the Module Desktop (3A) which in turn enables the Module (1M) on the users Module Desktop (3).
U. User Input

1U. User
1L. <<interface>> Module Listing
3. <<interface>> Module Desktop
   3A. Dropped Module at Location from Module Listing
   1M. <<program>> Module
C4. Module listing user interaction
R1. Drag & Drop to Module Desktop Interaction

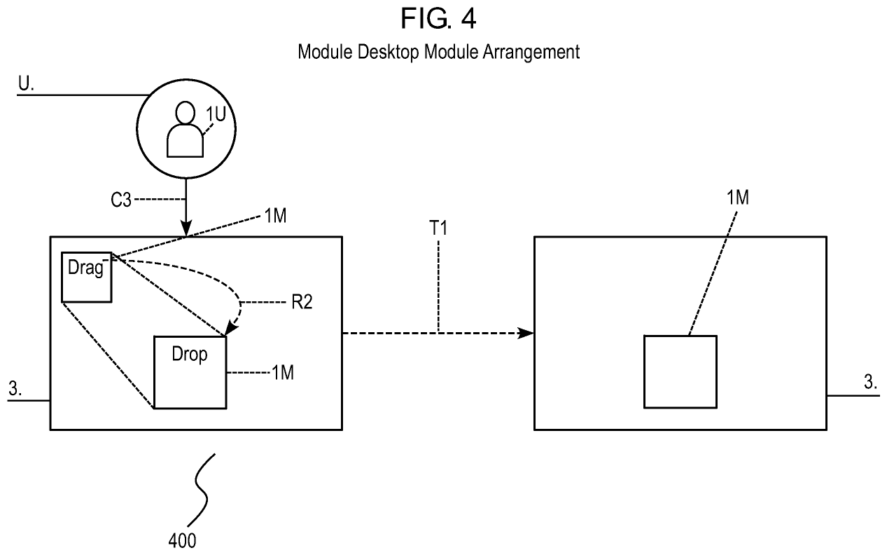

### FIG. 4 Module Desktop Module Arrangement

FIG. 4 illustrates functionality 400 associated with the client side computer for module arrangement on the module desktop.

Description: A User (1U) interacting (C3) with the Module Desktop (3) may drag and drop (R2) over time (T1) a Module (1M) to any position on the Module Desktop (3)
U. User Input
   1U. User
3. <<interface>> Module Desktop
   R2. Module Drag & Drop Operation
   1M. <<program>> Module
T1. Time
C3. Module desktop user interaction

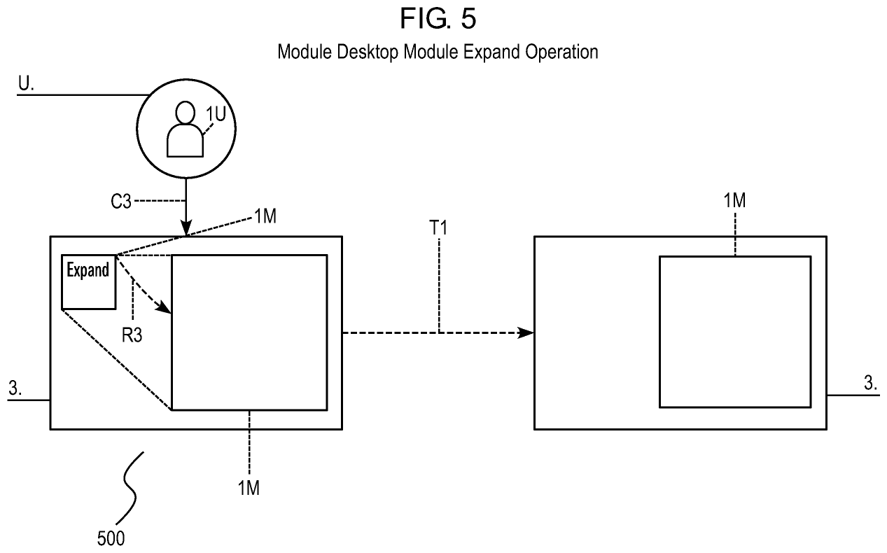

### FIG. 5 Module Desktop Module Expand Operation

FIG. 5 illustrates functionality 500 associated with the client side computer for module expanded display mode on the module desktop.

Description: A User (1U) interacting (C3) with the Module Desktop (3) may expand (R3) a module (1M) to a larger size over time (T1) within the Module Desktop (3) to expand the size of the Module (1M).
U. User Input
   1U. User
3. Module Desktop
   R3. Module Expand Operation
   1M. <<program>> Module
T1. Time
C3. Module desktop user interaction

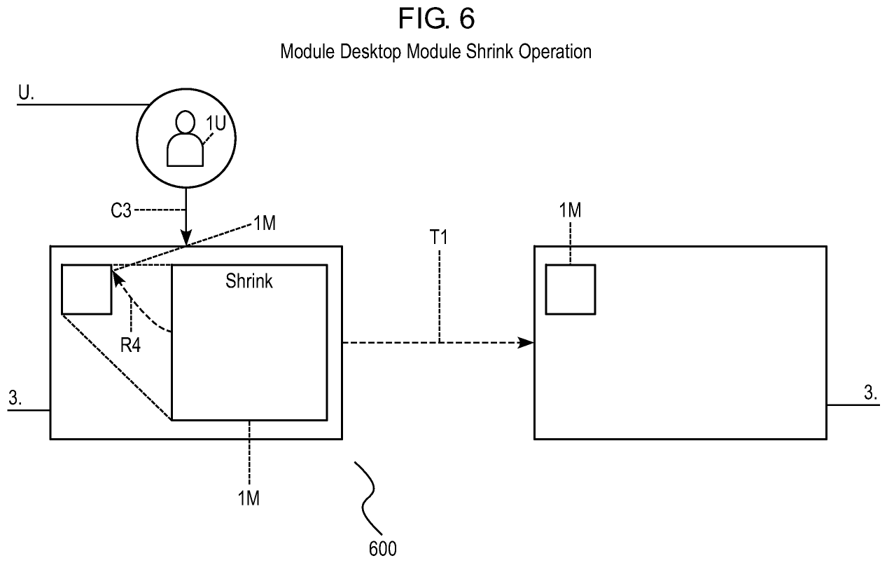

### FIG. 6 Module Desktop Module Shrink Operation

FIG. 6 illustrates functionality 600 associated with the client side computer for module shrink display mode on the module desktop.

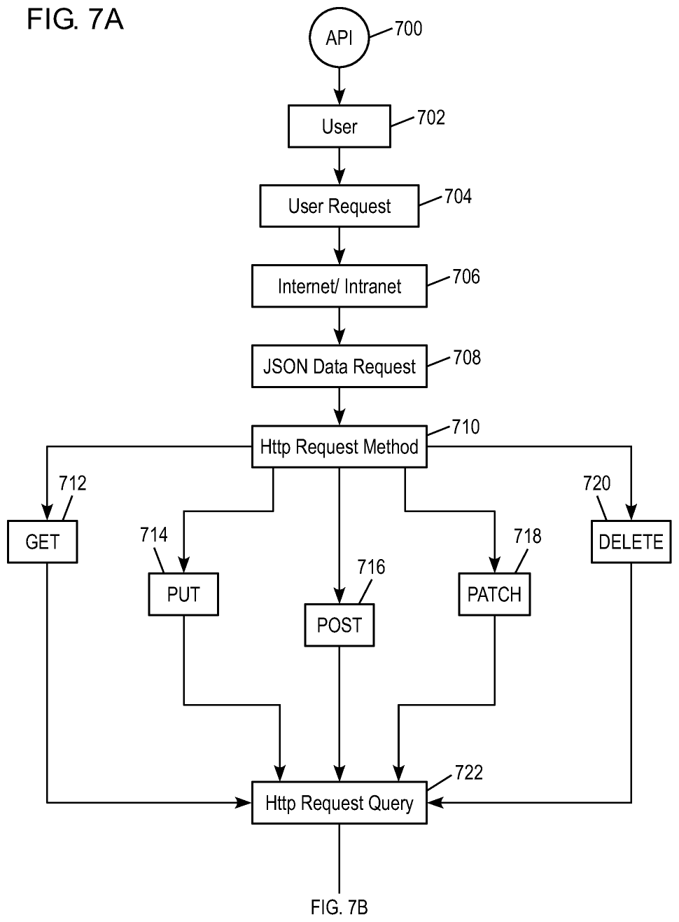

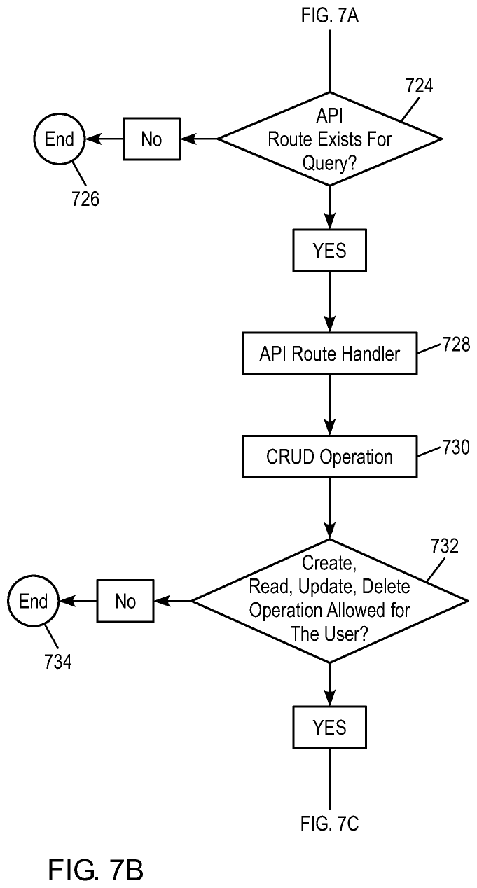

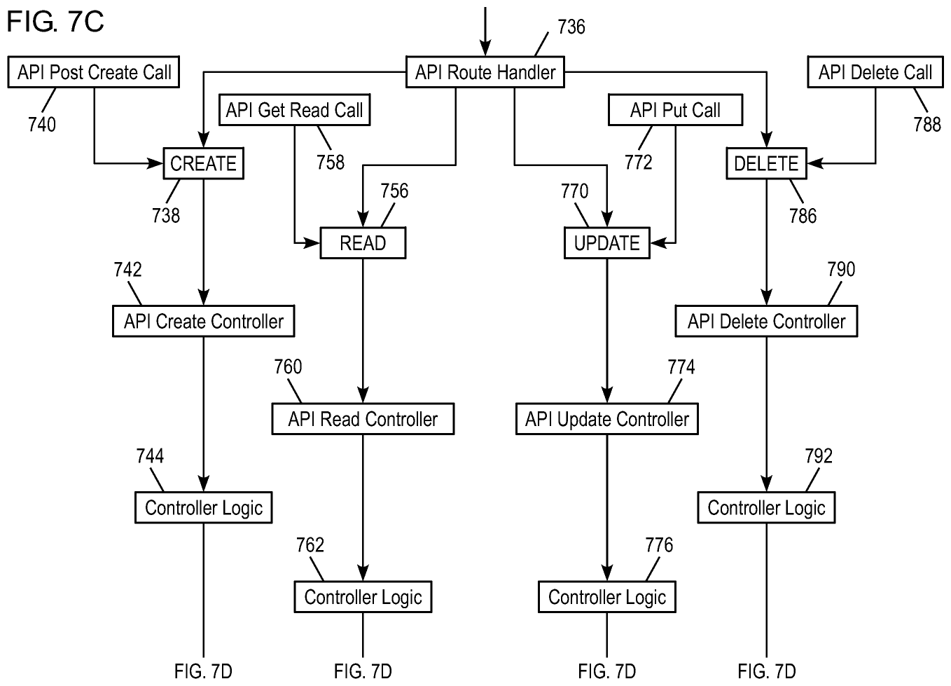

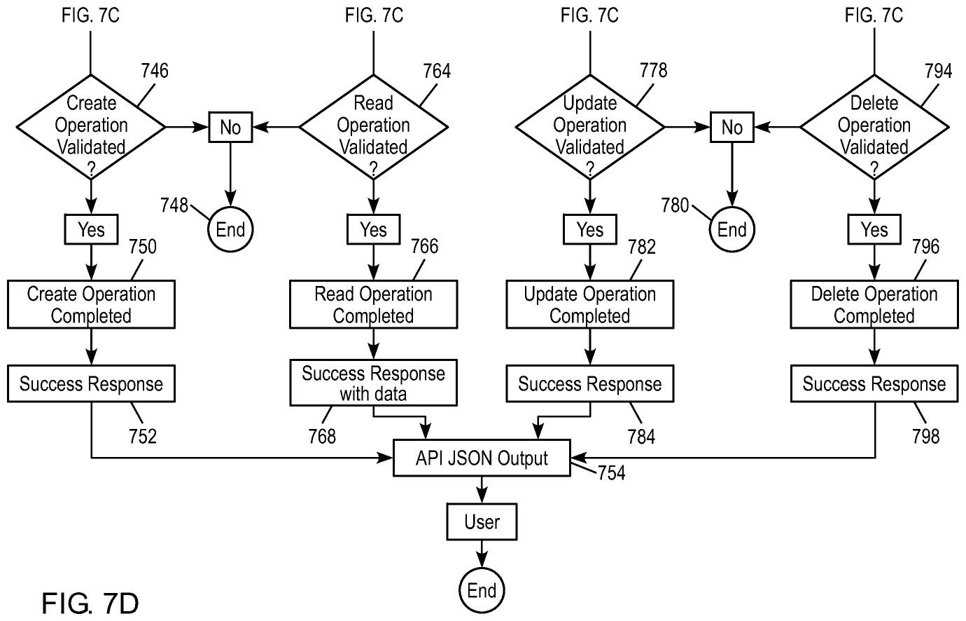

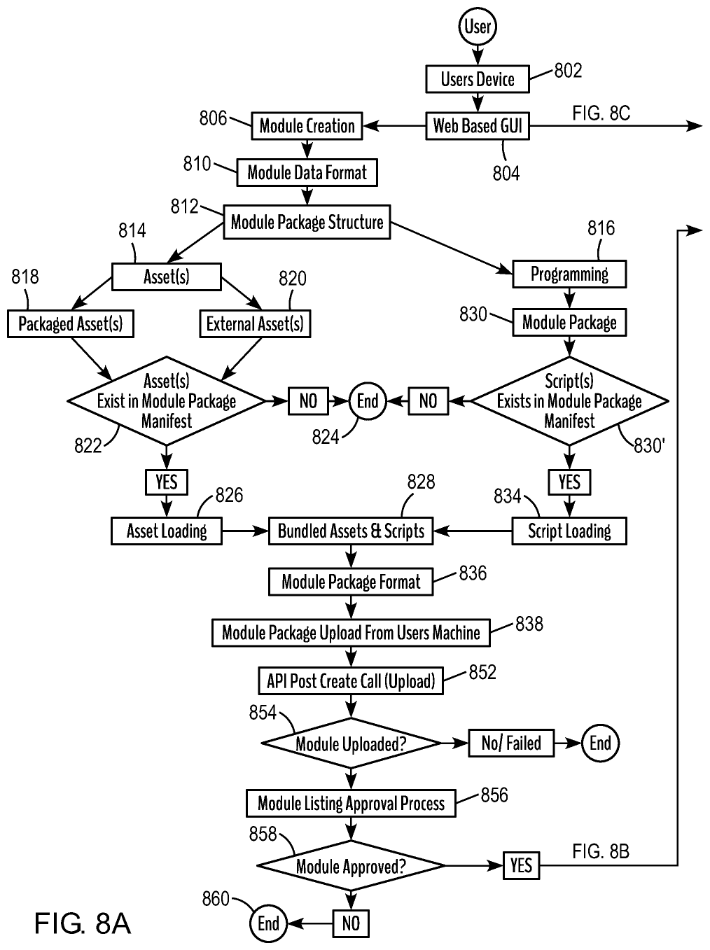

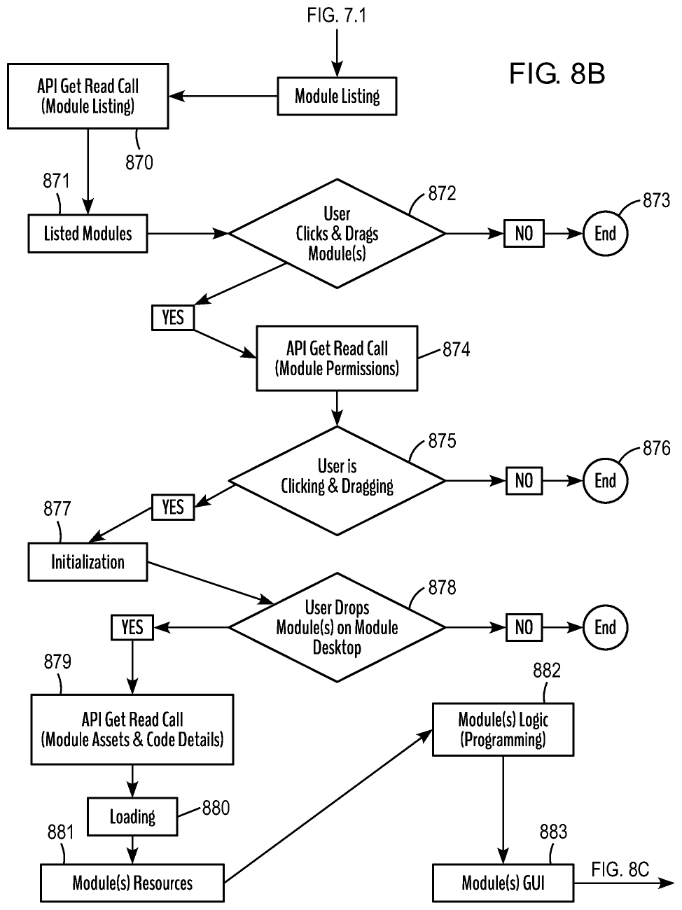

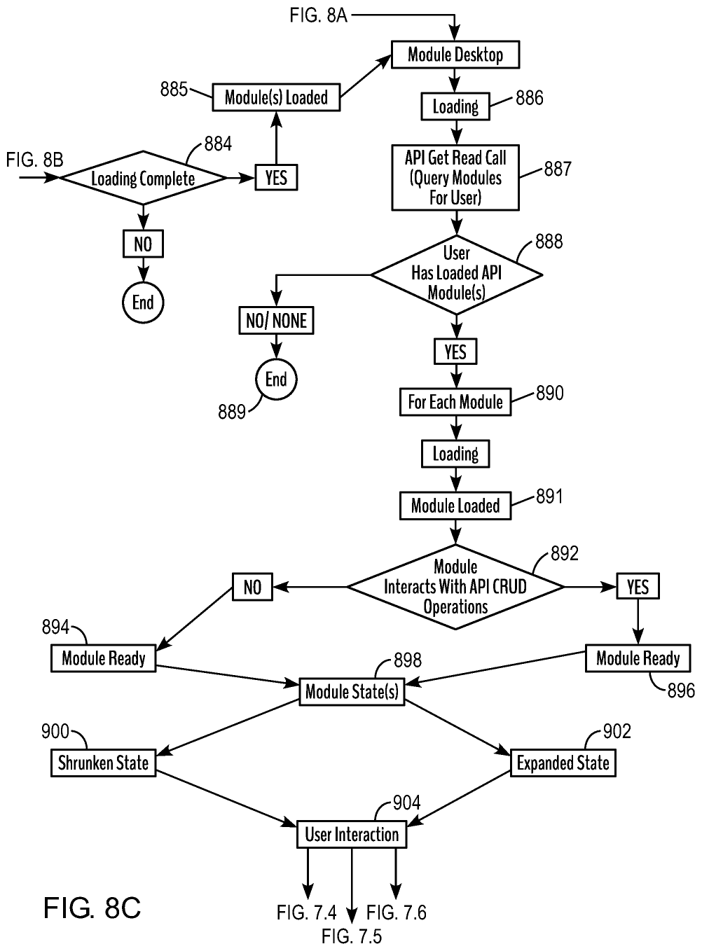

Description: A User (1U) interacting (C3) with the Module Desktop (3) may shrink (R4) a module (1M) to a smaller size over time (T1) within the Module Desktop (3) to shrink the size of the Module (1M).
U. User Input
   1U. User
3. Module Desktop
   R4. Module Shrink Operation
   1M. <<program>> Module
T1. Time
C3. Module desktop user interaction
   FIGS. 7a-7d Method of Operation (Server Side/Client Side Interaction)

FIGS. 7a-7d depict an exemplary flow chart of a method which can be implemented according to the present disclosure for a system having server side/client side interaction to establish a virtual, module desktop.

Referring to FIG. 7a, an initial diagram of an exemplary method of operation for server side/client side interaction is illustrated.

Referring to FIG. 7a an application program interface (API) 700 provides access from the client side to a user 702. A user request 704 is provided by the user to the server-side via for example and Internet/Internet connection 706. The request can produce a JSON data request 708. The request 708 produces an http method request 710 invocation.

The method request 710 can include actions of: get 712, put 714, post 716, patch 718 and delete 720. Any of these requests will produce an http request query 722.

Referring to FIG. 7b, following a request query 722, the method flows to a decision block 724 to determine whether an API route exists for the query. If not the query ends with end block 726. If a route exists, the flow proceeds to an API route handler 728 and then to a create, read, update, delete (CRUD) operation 730.

In decision block 732, determination is made as to whether the requested method of create, read, update or delete constitutes an operation for which the user is allowed permission to execute. If not the operation ends with and block 734. If the operation is permitted for the user, process flows to FIG. 7c.

Referring to FIGS. 7c and 7d, CRUD logic routing begins with routing 736 at the top of FIG. 7c whereby, depending on the user request, operation flows to the appropriate operation flow path. That is, for a create operation, operation flows to create block 738 with an associated API post create call 740, an API create controller 742 and associated controller logic 744. Referring to FIG. 7d, the create operation is validated as shown in decision block 746 and if the operation cannot be validated the operation is ended in the block 748. Otherwise the create operation is completed in block 750 and a success response is created in block 752.

In block 750 API JSON outputs are is provided and transmitted via the Internet/Internet connection 706 to the client side user.

Similar flow paths exist for the read, update and delete operations. The read operation includes exemplary blocks 756, 758, 760, 762, 764, 766 and 768. The update operation includes blocks 770, 772, 774, 776, 778, end block 780 and blocks 782, 784.

A delete operation includes blocks 786, 788, 790, 792, 794, 796 and 798, again leading to API JSON outputs.

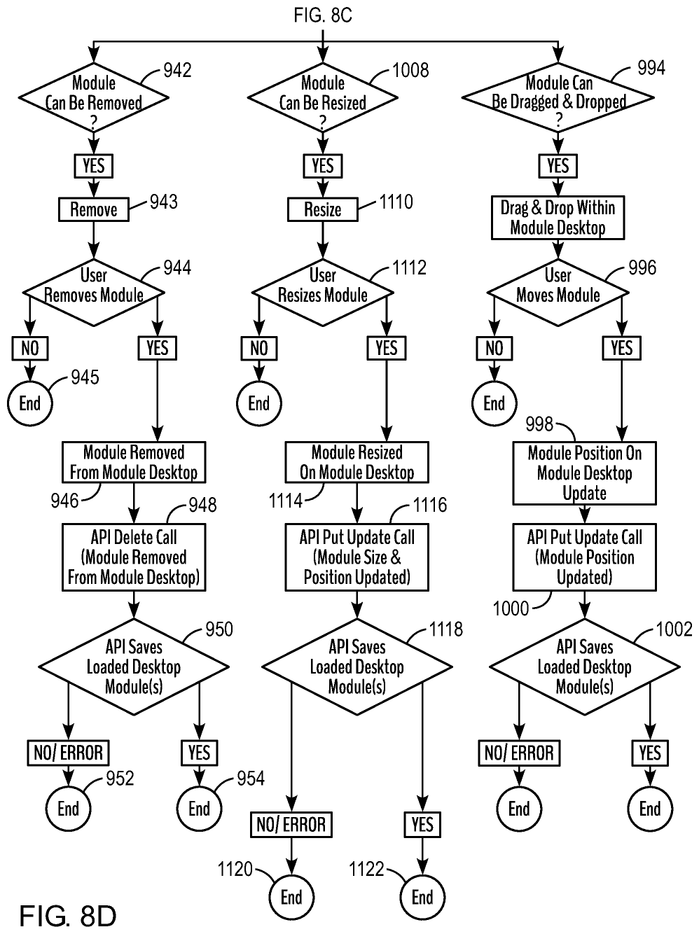

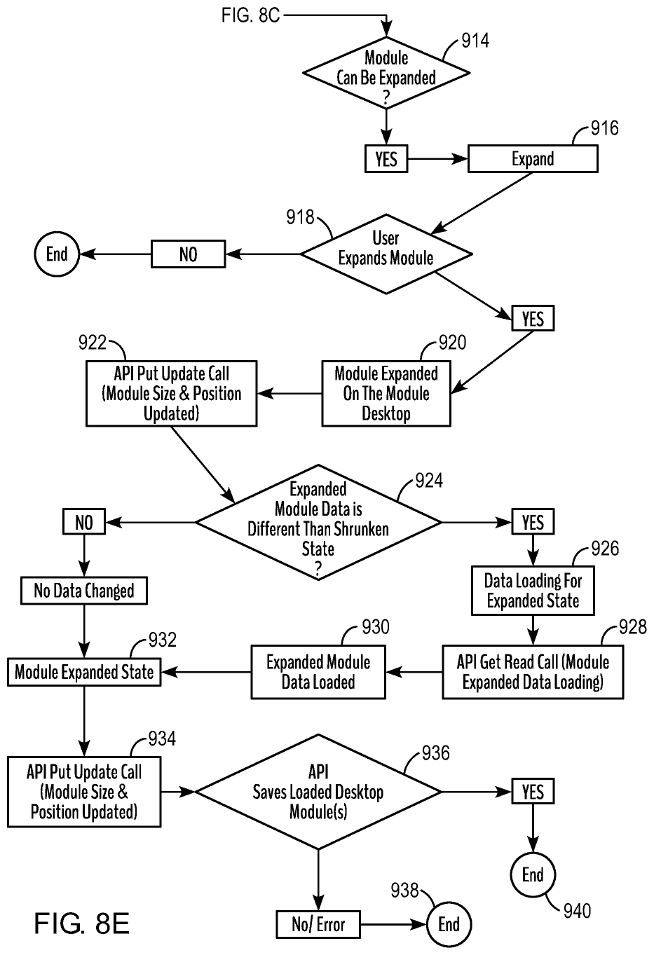

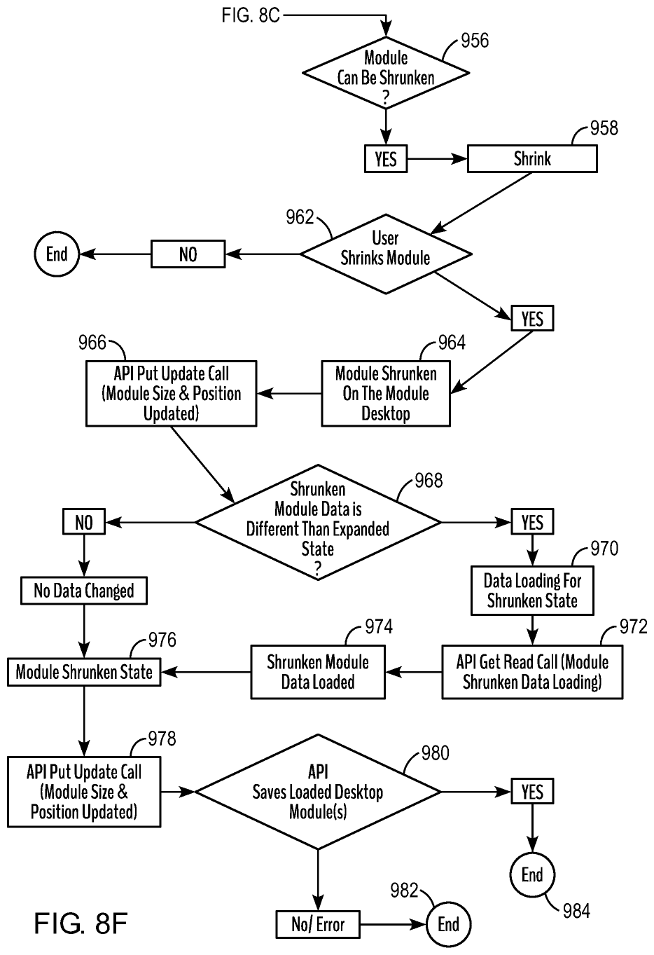

FIGS. 8a-8f: Module Creation, Access And Display

FIGS. 8a-8f show exemplary flow charts for client-side module creation and use, including module access and display on a client module desktop.

Referring to FIG. 8a, an overview diagram of an exemplary method of client-side module creation is illustrated, wherein a user can interact with the server side to build a package of module assets and programming scripts, bundled into a module format for upload to the server repository via the API for approval and storage so that the module can be accessed for future use.

Referring to FIG. 8b, an overview diagram of an exemplary method of client-side module click, drag and drop from a module listing displayed on the user module desktop for use on the module desktop is illustrated. Via the API, a user clicks an approved module (e.g., purchased by the user) for use on the module desktop after it has been loaded for access via the module listing on the client side module desktop GUI.

Referring to FIG. 8c, an overview diagram of an exemplary method of a client-side module display in saved display modes, such as expanded or shrunken modes, is illustrated.

Referring to FIG. 8d, an overview diagram of an exemplary method of client-side module removal, resizing and/or drag/drop operations is illustrated. Actions can be executed via the API as shown.

Referring to FIGS. 8e and 8f, overview diagrams of an exemplary method of client-side module display modes, such as expanded or shrunken modes respectively, are illustrated whereby data associated with expanded and shrunken states is stored for access via the API.

Referring to FIG. 8a, module creation, initialization, and use begins with a user interacting with a client side user device 802 for interfacing to a server via a web based GUI 804.

The module creation 806 flows to a module data format block 810, to a module package structure 812 and to asset process flows 814 and programming 816. Module assets can be packaged in block 818 or be external assets of block 820, after which a decision is made in decision block 822 as to whether the asset exist flag in the module package is manifested. If not creation ends in block 824. Otherwise process flows to asset loading in block 826 for bundling in block 828 (e.g., with appropriate scripts).

With regard to the programming block 816, process flows through a module package block 830 to a decision block 830. If the script exists, script loading occurs in block 834 for subsequent bundling in block 828.

In FIG. 8a, the module package upload of the module creation process flow transitions via formatting block 036 and upload 838 to module package API post create call upload block 852. If the module has been uploaded, process flows through decision block 854 to module approval process decision block 858. Otherwise the module upload operation is deemed to have failed and operation ends at block 860.

FIG. 8b illustrates a module listing of an approved module. In FIG. 8b, process flows through an API get read call block 8706 to form listing modules in block 871, followed by a decision block for click and drag operability in block 872. The module listing is complete and transitions to end block 873 if no click and drag capability is to be provided. Otherwise process flows to an API get read call 874, and on to a click and drag decision block 875. If no click and drag is desired, process ends with end block 876. Otherwise process flows to initialization block 877.

The FIG. 8b initialization process flows via a “drop” decision block 878 to an API get read call 879, a loading block 880, a module resources block 881, a module logic programming block 882, a module GUI block 883 and a FIG. 8c loading complete decision block 884, ending with end block 878 or transitioning with loaded modules in block 885 to the further operation of FIG. 8c.

Referring to FIG. 8c, further details regarding the loading 886 of a module via an API Get Read Call 887 are illustrated with decision block 888. If no further modules are to be loaded the process ends with end block 884. Otherwise, if yes, process flows through blocks 890 for each module, to a loading block 891. A module loaded block 891, a CRUD decision block 892, module ready blocks 894 and 896, and a module state block 898 follow. From the module state block 898, process flows to a shrunken state block 900, or to a module expanded state 902 for user interaction.

Regardless of the shrunken or expanded state, operation returns to user interaction block 904 and then on to various decision blocks regarding actions associated with the module such as expansion blocks or module removal blocks of FIGS. 8d-8f.

FIG. 8d illustrates a remove operation and includes decision block 942, remove block 943, and decision block 944 with end block 945, and associated module removal blocks 946, 948 (ADI delete call) and an API save of load desktop modules decision block 950 with associated end blocks 952 (no save, or error), 954 (save).

Referring to FIG. 8d, the far right hand column illustrates a process flow with regard to a drag and drop within the module desktop as block 994. A drag and drop includes a move decision block 996, associated blocks 998, 1000 (API Put Update Call) and decision block 1002 for saving the module, with associated end blocks 1004 (no save or error), 1006 (save).

A resize operation 1008 (e.g., for (position update) reuse of a pre-existing module on a different application or with different data) can be configured with a similar resize process 1110 having a similar decision block 1112 and associated blocks 1114, 1116 followed by a decision block 1118 for saving the module, with associated end blocks 1120, 1122.

Referring to FIG. 8e, the module expansion operation includes decision/expand blocks 914, 916 and decision block 918 with module expansion 920 and API Put Update 922, blocks 924, 926 for data changed, blocks 928, 930, 932 for data loading for expanded state, followed by an API put update call 934 and a loaded module save block 936, with associated end blocks 938, 940

Referring to FIG. 8f, operations associated with module operations of user-requested shrink operations and reuse operations (i.e., implemented in similar fashion) are illustrated. Shrink operation is illustrated with regard to decision block 956, shrink block 958 decision block 962, module shrunken block 964, API Put Update Call 966 and data upload decision block 968 for no data change, or for data change, with blocks 970 (data load) 972 (API Get Read), 974 (data load), module block 976 and followed by an update of the module as shrunken via API put update call 978, and the saving of the module via blocks 980 and associated and blocks 982, 984.

In FIG. 8f, process flow for shrinking a module determines whether a data set associated with a shrunken module is different than in an expanded state (block 968), similar to the FIG. 8c data comparison of block 924.

Thus, it therefore be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A desktop system for establishing a web-based virtual, module desktop on a client computer for selection and execution of software modules, the system comprising:
a local memory for storing a web browser;
a computer processor configured to access the memory and execute the web browser; and
a general user interface configured to display a web-based module desktop that runs within the web browser;
wherein the computer processor is configured to receive from an external server memory module repository at least one or more software modules, and to allow a user to drag and drop modules onto the web-based module desktop from a module listing received from the external server memory and displayed on the web-based module desktop; and
wherein a software module to be executed on the desktop computer processor is at least one of an application software module or a utility software module.

2. The system according to claim 1, wherein the computer processor is configured to request remote execution of an additional software module without local storage of the software module.

3. (canceled)

4. The system according to claim 1, wherein the computer processor is configured to request display of a software module at the client computer in either a compact view or an expanded view in response to a user selection.

5. The system according to claim 1, wherein the computer processor is configured to allow the client computer to request purchase of a software module for storage in the module repository, such that upon purchase the software module will be stored with a link to the client computer or to a specific user and or group.

6. The system according to claim 1, wherein the computer processor is configured to allow the client computer to develop a user-configured software module for remote storage in a module repository with a link to the client computer or to a specific user and or group.

7. The system according to claim 1, wherein the computer processor is configured to establish a web-based virtual module desktop that is unique to the client computer or to a specified user account identified by a user of the client computer.

8. The system of claim 1, in combination with a server memory module repository storing at least one or more software modules.

9. The system of claim 8, in combination with a computer processor configured to:
access the server memory module repository; and
to serve software modules stored therein to the web-based client computer upon receipt of a user requested selection by the web-based client computer.

10. A server side system for establishing a web-based virtual, module desktop on a client computer for selection and execution of software modules, the system comprising:
a server memory module repository storing at least one or more software modules;
a computer processor configured to:
access the server memory module repository;
to serve software modules stored therein to a web-based client computer upon receipt of a user requested selection; and
to allow a user to select software modules for execution by a drag and drop function performed at the client computer;
the computer processor also being configured to serve modules onto the web-based client computer virtual module desktop from a module listing served to the web-based module desktop computer for display and access by a user and or group; and
wherein a software module to be executed on the desktop computer processor is at least one of an application software module or a utility software module.

11. The system according to claim 10, wherein the computer processor is configured to execute an additional software module in response to user commands from a client computer without serving the software module to the client computer.

12. (canceled)

13. The system according to claim 10, wherein the computer processor is configured to serve a software module in either a compact view or an expanded view in response to a user selection received by the computer processor.

14. The system according to claim 10, wherein the computer processor is configured to allow a client computer to request purchase of a software module for storage in the module repository with a link to the client computer or to a specific user and or group.

15. The system according to claim 10, wherein the computer processor is configured to allow the client computer to develop a user-configured software module for storage in the module repository with a link to the client computer or to a specific user and or group.

16. The system according to claim 10, wherein the computer processor is configured to establish a web-based virtual module desktop that is unique to a specified client computer or user account.

17. The system according to claim 10, in combination with a web-based client computer configured for accessing the server memory module repository storing at least one or more software modules.

18. A method for establishing a web-based virtual, module desktop on a client computer for selection and execution of software modules, the method comprising:
storing at least one or more software modules on a server memory module repository;
executing within a server side computer processor a computer program for causing the computer processor to:
access the server memory module repository;
to serve software modules stored therein to a web-based client computer upon receipt of a user requested selection; and
to allow a user to select software modules for execution by a drag and drop function performed at the client computer; and
serving one or more modules onto the web-based client computer virtual module desktop from a module listing served to the web-based module desktop computer for display and access by a user;
wherein a software module to be executed on the desktop computer processor is at least one of an application software module or a utility software module.

19. The method according to claim 18, wherein the computer processor is configured to:
execute an additional software module in response to user commands from a client computer without serving the software module to the client computer.

20. The system according to claim 18, wherein the computer processor is configured to:
serve a software module in either a compact view or an expanded view in response to a user selection received by the computer processor.

21. The method according to claim 18, wherein the computer processor is configured to:
allow a client computer to request purchase of a software module for storage in the module repository with a link to the client computer or to a specific user and or group.

22. The method according to claim 18, wherein the computer processor is configured to:
allow the client computer to develop a user-configured software module for storage in the module repository with a link to the client computer or to a specific user and or group.

23. The method according to claim 18, wherein the server side computer processor is configured to:
establish a web-based virtual module desktop that is unique to a specified client computer, group, or user account.

24. The system according to claim 1, wherein the computer processor is configured to execute an approved module purchased by a user for use on the module desktop after it has been loaded from a server for access via the module listing on the client side module desktop.

25. The system according to claim 1, wherein the computer processor is configured to initiate module creation, initialization, and use for response to a user interacting with the client side interface to a server via the general user interface (GUI) configured as a web based GUI.

26. The system according to claim 1, wherein the computer processor is configured to perform module creation via a module data format block, using a module package structure and module assets which include assets external to the module.

27. The system according to claim 1, wherein the computer processor is configured to perform an initialization process and an API call for loading a module block, a module resources block, a module logic programming block, and a module GUI block.
